(19) United States
(12) Patent Application Publication
(10) Pub. No.: US 2005/0185707 A1
(43) Pub. Date: Aug. 25, 2005

(54) Method and system for antenna selection diversity with minimum threshold

(76) Inventors: Min Chuin Hoo, Sunnyvale, CA (US); Rajendra Tushar Moorti, Mountain View, CA (US)

Correspondence Address: MCANDREWS HELD & MALLOY, LTD, 500 WEST MADISON STREET, SUITE 3400, CHICAGO, IL, 60661, US

(21) Appl. No.: 10/810,408

(22) Filed: Mar. 26, 2004

Related U.S. Application Data
(60) Provisional application No. 60/547,366, filed on Feb. 24, 2004.

(51) Int. Cl. H04B 17/00; H04L 1/02; H04B 1/10

(52) U.S. Cl. 375/224; 375/347; 375/349

(57) ABSTRACT

Methods and systems for selecting at least one signal path are disclosed. Aspects of the method may comprise determining a signal quality metric for each of a plurality of signal paths and assigning a threshold signal quality metric for the plurality of signal paths. A signal path may be discarded from the plurality of signal paths, if the determined signal quality metric for the signal path does not satisfy the threshold signal quality metric. A different threshold signal quality metric and/or a fixed threshold signal quality metric may be assigned for each of the plurality of signal paths. The threshold signal quality metric may be dynamically changed for each of the plurality of signal paths.

### CROSS-REFERENCE TO RELATED APPLICATIONS/INCORPORATION BY REFERENCE

This application makes reference to, claims priority to, and claims the benefit of U.S. Provisional Application Ser. No. ______ (Attorney Docket No. 15574US01) filed Feb. 24, 2004 and entitled “Method and System for Antenna Selection Diversity and Dynamic Gain Control.”

This application makes reference to:
U.S. Utility application Ser. No. ______ (Attorney Docket No. 15574US02) filed Mar. 26, 2004.
U.S. Utility application Ser. No. ______ (Attorney Docket No. 15575US02) filed Mar. 26, 2004.
U.S. Utility application Ser. No. ______ (Attorney Docket No. 15624US02) filed Mar. 26, 2004.

The above stated applications are hereby incorporated herein by reference in their entirety.

### FIELD OF THE INVENTION

Certain embodiments of the invention relate to wireless communication. More specifically, certain embodiments of the invention relate to a method and system for antenna selection diversity with minimum threshold.

### BACKGROUND OF THE INVENTION

In a wireless communication system a data stream will most likely experience multiple reflections (multipath) while propagating between the transmitter and the receiver. Multipath fading implies that multiple copies of the transmitted signal follow different paths and reach the receiving antenna with different time delays. In such cases the received signal strength at a given time is the result of destructive and constructive interference of the multiple paths arriving from different directions. Destructive interference degrades the performance of the detector and hence adversely affects the system capacity. However, by using multiple antennas at the receiver and with appropriate digital signal processing methods, multipath can be exploited to enhance the performance and robustness of the receiver and to increase the reliability of the communications link. The receiving antennas generally must be spaced sufficiently far apart that the signal each antenna sees is not correlated with the signals seen by the other antennas. One such method of mitigating multipath fading is called selection diversity.

The algorithm for selection diversity is based on selecting the best signal among all the signals detected at the receiver antennas. Let Pᵢ denote the power estimated at antenna i at the receiver. Then, the selection diversity scheme will select antenna j as the receive antenna if Pⱼ>Pᵢ, i≠j. Higher accuracy in estimating the powers Pᵢ results in higher probability of the right receive antenna being selected and better performance of the selection diversity scheme. Two main factors that affect the accuracy of the power estimates Pᵢ may include a dwell time on all antennas other than the target antenna and presence of impairments such as noise, transients and offsets.

With regard to the presence of impairments such as noise, transients and offsets, impairments corrupt the power estimates Pᵢ and may result in misestimations of the power. Such misestimations of power may result in the selection of antenna j as the receive antenna even if Pⱼ<Pᵢ for some other antenna i. In addition, antennas may be receiving signals at or near a certain noise level. Processing such signals may involve utilizing expanded time resources and, ultimately, incorrect power estimation and antenna selection may occur.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for selecting at least one signal path for an antenna system associated with a receiver, transmitter and/or a transceiver. Aspects of the method may include determining a signal quality metric for each of a plurality of signal paths and assigning a threshold signal quality metric for the plurality of signal paths. A signal path may be discarded from the plurality of signal paths, if the determined signal quality metric for the signal path does not satisfy the threshold signal quality metric. A different threshold signal quality metric and/or a fixed threshold signal quality metric may be assigned for each of the plurality of signal paths. The threshold signal quality metric may be dynamically changed for each of the plurality of signal paths. The signal quality metric may include, but is not limited to, a power level characteristic, a packet error rate characteristic, a bit error rate characteristic, a propagation channel characteristic, and/or an interference level characteristic. One or more of the signal paths may comprise an antenna and each of the signal paths may comprise a receive signal path and/or a transmit signal path.

Another embodiment of the invention may provide a machine-readable storage, having stored thereon, a computer program having at least one code section executable by a machine, thereby causing the machine to perform the steps as described above for selecting at least one signal path.

Aspects of the system for selecting at least one signal path may include at least one processor that determines a signal quality metric for each of a plurality of signal paths. The at least one processor may assign a threshold signal quality metric for the plurality of signal paths. If the determined signal quality metric for the signal path does not satisfy the threshold signal quality metric, the at least one processor may be adapted to discard a signal path from the plurality of signal paths. The at least one processor may assign a different threshold signal quality metric for each of the plurality of signal paths and/or a fixed threshold signal quality metric for each of the plurality of signal paths. The at least one processor may dynamically change the threshold signal quality metric for each of the plurality of signal paths. The signal quality metric may include, but is not limited to, a power level characteristic, a packet error rate characteristic, a bit error rate characteristic, a propagation channel characteristic, and/or an interference level characteristic. One or more of the signal paths may comprise an antenna and each of the signal paths may comprise a receive signal path and/or a transmit signal path.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram of an exemplary receiver system that may be utilized in connection with selection diversity with dynamic gain control, in accordance with an embodiment of the invention.

FIG. 1B is a diagram of an exemplary antenna switch in a receiver system that may be utilized with selection diversity with dynamic gain control, in accordance with an embodiment of the invention.

FIG. 2A illustrates exemplary received powers by different antennas in a receiver system, in accordance with an embodiment of the invention.

FIG. 2B illustrates exemplary antenna dwell times, signal gain, and antenna selection in a receiver system in connection with selection diversity with dynamic gain control, in accordance with an embodiment of the invention.

FIG. 3A illustrates exemplary received powers by different antennas in a receiver system, in accordance with an embodiment of the invention.

FIG. 3B illustrates exemplary antenna dwell times, signal clipping, and antenna selection in a receiver system in connection with selection diversity with dynamic gain control, in accordance with an embodiment of the invention.

FIG. 3C illustrates exemplary antenna dwell times, dynamic gain control, and antenna selection, in accordance with an embodiment of the invention.

FIG. 4A illustrates exemplary received powers by different antennas in a receiver system, in accordance with an embodiment of the invention.

FIG. 4B illustrates exemplary antenna dwell times, dynamic gain control, and antenna selection, in accordance with an embodiment of the invention.

FIG. 5 is a flow chart illustrating exemplary steps that may be utilized in a receiver system for antenna selection with dynamic gain control, in accordance with an embodiment of the invention.

FIG. 6 is a flow diagram of an exemplary method for selecting a signal path, in accordance with an embodiment of the invention.

### DETAILED DESCRIPTION OF THE INVENTION

Certain aspects of the invention may be found in a method and system for selecting at least one signal path. Within a set of signal paths, a signal quality metric may be determined for each signal path and a threshold signal quality metric may then be assigned for each signal path. If the determined signal quality metric for a signal path does not satisfy the threshold signal quality metric, the signal path may be discarded from the set of signal paths. A different threshold signal quality metric and/or a fixed threshold signal quality metric may be assigned for each signal path. The signal quality metric may include, for example, a power level characteristic, a packet error rate characteristic, a bit error rate characteristic, a propagation channel characteristic, and/or an interference level characteristic. The threshold signal quality metric may be dynamically changed for each of the plurality of signal paths. One or more of the signal paths may include an antenna and each of the signal paths may include a receive signal path and/or a transmit signal path.

Certain other embodiments of the invention may also be found in a method and system for antenna selection diversity with dynamic gain control. Wireless communication systems may utilize receivers with multiple antennas to enhance the performance and robustness of the receiver and to increase the reliability of the communications link. Certain aspects of the method may comprise dwelling on at least one of several antennas in a receiver system in order to select a portion of those antennas for signal processing, determining a gain, and determining a signal quality metric for the dwelled-on antennas. The power may be an estimated received power or it may be a received power. Selecting the portion of antennas that may be used for signal processing may be based on the gain, the estimated signal quality metric, and/or the received signal quality metric of the dwelled-on antennas.

A starting antenna may be selected from the antennas in the receiver system based on a predetermined criteria, random selection, and/or on information of which dwelled-on antennas or portion of dwelled-on have been selected for signal processing in the past. A starting gain for the starting antenna may be determined by using an automatic gain control.

Other antennas in the receiver system may be selected for dwelling based on a predetermined criteria. For each of the dwelled-on antennas, a gain may be determined dynamically based on the gain, the signal quality metrics, and/or on at least one of the power coupling parameters that may be measured between the antenna switch outputs in the receiver. The signal quality metrics may be an estimated received power, a received power, a signal-to-noise ratio, a bit error rate, a packet error rate, a propagation channel characteristic, an/or a channel interference. Selecting a portion of the dwelled-on antennas for signal processing in the current frame may be based on a comparison against a specified range of levels for at least one signal quality metric.

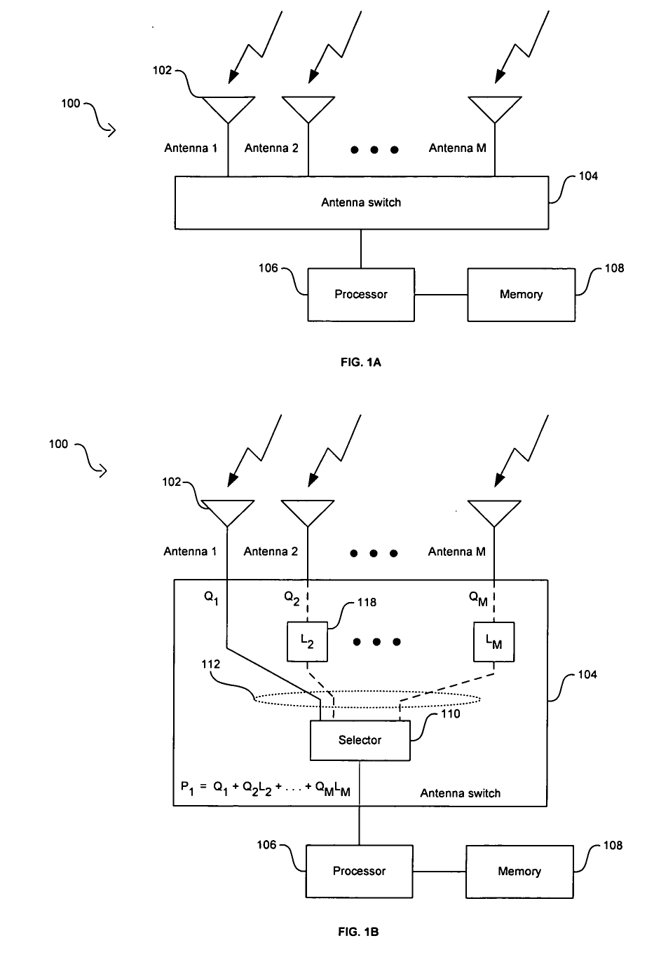

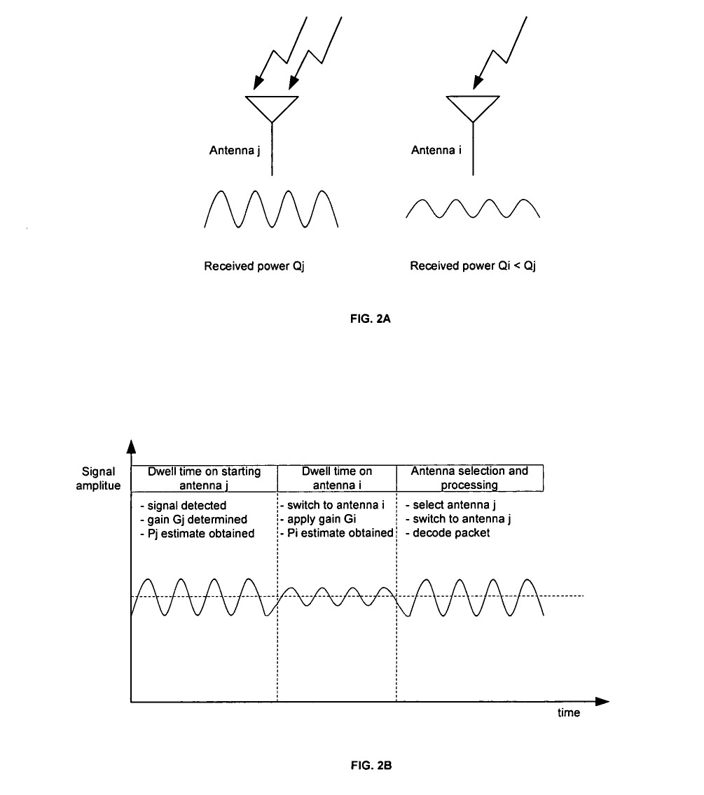

FIG. 1A is a diagram of an exemplary receiver system that may be utilized in connection with selection diversity with dynamic gain control, in accordance with an embodiment of the invention. Referring to FIG. 1A, the receiver system 100 may comprise at least one antenna 102, an antenna switch 104, a processor 106, and a memory 108. There may be as many as M antennas 102 coupled to the antenna switch 104. The antenna 102 may be part of an independent antenna array of antennas coupled to the antenna switch 104, may be one of several individual antennas coupled to the antenna switch 104, and/or may be one of several integrated individual antennas and/or may be part of an integrated array of antennas coupled to the antenna switch 104. The antenna switch 104 may be a mechanical, electronic, electromechanical, and/or microelectromechanical (MEM) switch. The processor 102 may be a hardware resource, a core processor, a coprocessor, a digital signal processor, or a microcontroller. The memory 108 may be an external memory, an embedded memory, a shared memory, or a main memory. The memory 108 may be an SRAM and/or DRAM type memory.

The incoming wireless signal may be received by at least one antenna 102. The antenna switch 104 may select the antenna channel of any antenna 102. The processor 106 may notify the antenna switch 104 which antenna channel corresponding to a particular antenna 102 to select. The processor 106 may be utilized to determine which antenna 102 may be the starting antenna, to determine which antenna 102 to select next, to determine the dwell time in each selected antenna, to detect and decode the incoming signal, and to amplify or apply a gain to the signal. The processor 106 may apply gain to the signal from an antenna channel by utilizing an automatic gain control (AGC) or by determining a specific gain to apply. The processor 106 may be utilized to determine the estimated power of the signal, to determine a signal-to-noise ratio, to determine a packet-error-rate or bit-error-rate, to transfer information to and from memory 108, and to determine statistics based on information from several transmitted frames stored in memory 108. The memory 108 may be utilized to store information processed by the processor 106 that may be associated with any antenna 102 in any number of transmitted frames.

In operation, the processor 106 may notify the antenna switch 104 which antenna 102 may be used as the starting antenna. The processor 106 may determine which antenna 102 to use for the starting antenna based on information from preceding frames that may be stored in memory 108. The antenna switch 104 may select the antenna channel that corresponds to the selected antenna 102. The processor 106 may dwell on the starting antenna until it detects an incoming signal. Once the signal is detected, an AGC may be applied to obtain a sufficiently strong signal for decoding. The processor 106 may determine the estimated received power for the starting antenna and may store the value in memory 108. The processor 106 may then notify the antenna switch 104 to select the next antenna 102 for detection. The processor 106 may determine which antenna 102 to use as the next antenna based on information from preceding frames that may be stored in memory 108. The antenna switch 104 may select the antenna channel that corresponds to the next antenna. The processor 106 may dwell on the next antenna and apply a predetermined gain because the dwell time may be insufficient for an AGC to run its full operation. The processor 106 may determine the estimated received power for the next antenna and may store the value in memory 108. A similar procedure may be carried out with the remaining antennas in receiver system 100. Wit the exception of the starting antenna, a predetermined gain may be applied to all the other antennas because dwell time in all but the starting antenna is limited. The processor 106 may determine an estimated received power for all antennas in receiver system 100 and store the values in memory 108. The processor 106 may select the best antenna for decoding by selecting the highest estimated received power to determine the antenna 102 which has the strongest signal. The processor 106 may then notify the antenna switch 104 to select the antenna channel that corresponds to the antenna 102 with the strongest signal for decoding. The processor 106 may then detect and decode the signal from the selected best antenna and may store information associated with the antenna 102 it selected as the best antenna for the current frame.

FIG. 1B is a diagram of an exemplary antenna switch in a receiver system that may be utilized with selection diversity with dynamic gain control, in accordance with an embodiment of the invention. Referring to FIG. 1B, in this exemplary diagram, the selector 110 in antenna switch 104 may be configured to connect antenna 1 to processor 106. In this case, the incident power Q₁ in antenna 1 is received by processor 106. Moreover, because the isolation between antenna channels 112 in antenna switch 104 is not perfect, in this configuration the processor 106 may also receive, when detecting a signal in antenna 1, part of the incident powers Q₂ through Q_{M} received by antennas 2 through M. The amount of each incident power Q₂ through Q_{M} from antennas 2 through M received by processor 106 when detecting a signal in antenna 1 may be attenuated by power coupling factors 118 L₂ through L_{M}. The factors L₂ through L_{M} correspond to the proportion of the incident powers received by antennas 2 through M that will show in the antenna channel 112 of antenna 1 because of the imperfect isolation in antenna switch 104. The total estimated power received by processor 106 from antenna 1 is P₁=Q₁+Q₂L₂+ . . . +Q_{M}L_{M}.

For illustration, when Q₁<<QᵢLᵢ, i≠1 and that Q₂L₂ is dominant, the estimated received power received by processor 106 may reduced to P₁=Q₂L₂. In this case, a maximum power of interest at antenna 2 may be given by P₁/L₂, which is the estimated received power of antenna 1 divided by a measured power coupled factor between antennas 1 and 2. Therefore, the gain setting found for antenna 1 by the AGC through a long dwell time may be backed-off for use in antenna 2 to allow for a signal whose power is as large as P₁/L₂ to be detected properly at antenna 2. The gain for antenna 2 may not need to be predetermined but may be dynamically adjusted in each received frame. Repeating the same exercise for cases where Q₃L₃, . . . , or Q_{M}L_{M} dominates, the maximum power of interest is P₁/Lⱼ, where Lⱼ=max(Lᵢ, i≠1) is the power coupling factor 118 for antenna j. Since Lⱼ is known, backing-off the gain setting found for antenna 1 to allow for P₁/Lⱼ to be detected properly at antenna j may also allow for P₁/Lᵢ, i≠j, 1 to be detected properly at antenna i. The gain setting for all antennas other than the starting antenna may be dynamically set as it is backed-off from the gain setting found for antenna 1. If there is sufficient time, the gain back-off may be implemented in more than one step. In this regard, a time required to finish dynamic gain control is much less than a time required to run a full automatic gain control (AGC) on each of the antenna channels in receiver system 100.

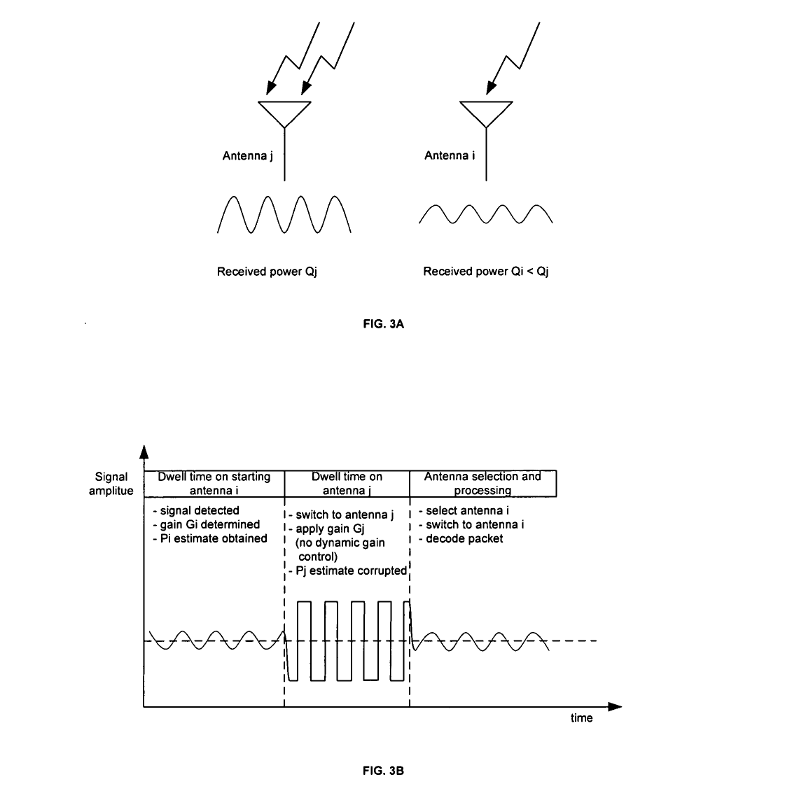

FIG. 2A illustrates exemplary received powers by different antennas in a receiver system, in accordance with an embodiment of the invention. Referring to FIG. 2A, in this exemplary illustration the receiver system 100 may be a two antenna system comprising antenna j and antenna i. The receiver system 100 may determine whether antenna j or antenna i may be selected as the best antenna for decoding the incoming frame or packet information. Antenna j receives a stronger received power than antenna i (Qᵢ<Qⱼ) and therefore receiver system 100 should select antenna j for signal decoding.

FIG. 2B illustrates exemplary antenna dwell times, signal gain, and antenna selection in a receiver system in connection with selection diversity with dynamic gain control, in accordance with an embodiment of the invention. Referring to FIG. 2B, the receiver system 100, in determining whether it should select antenna j or antenna i in FIG. 2A for signal decoding, may first dwell on antenna j, if antenna j was selected as the starting antenna. Once the signal is detected, the gain Gⱼ may be determined for antenna j. The processor 106 may determine an estimated received power Pⱼ for antenna j. The processor 106 may then dwell on antenna i by notifying the antenna switch 104 to select antenna i for detection. The gain Gᵢ for antenna i may be set to correspond to the gain Gⱼ or lower for antenna j or to a predetermined value. In that case, the processor 106 may determine an estimated received power for antenna i that may be lower than the estimated received power for antenna j. After dwelling on both antenna j and antenna i, the processor 102 may correctly select antenna j as the one with the strongest signal, notify the antenna switch 104 to select antenna j, and use the signal from antenna j for decoding the packet being received in the current frame. As long as the antenna with the strongest signal is the same as the antenna that the receiver system 100 selects as the starting antenna, setting the gain of all following antennas to correspond to the gain of the first antenna may result in the correct antenna selection.

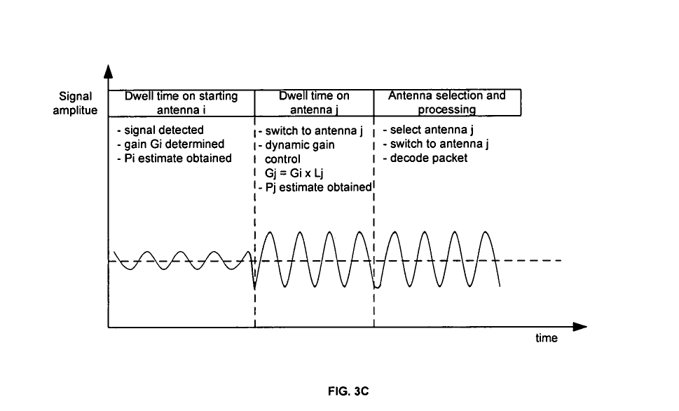

FIG. 3A illustrates exemplary received powers by different antennas in a receiver system, in accordance with an embodiment of the invention. Referring to FIG. 3A, in this exemplary illustration the receiver system 100 may be a two antenna system comprising antenna j and antenna i. The receiver system 100 may determine whether antenna j or antenna i may be selected as the best antenna for decoding the incoming frame or packet information. Antenna j receives a stronger received power than antenna i (Qᵢ<Qⱼ) and therefore receiver system 100 should select antenna j for signal decoding.

FIG. 3B illustrates exemplary antenna dwell times, signal clipping, and antenna selection in a receiver system in connection with selection diversity with dynamic gain control, in accordance with an embodiment of the invention. Referring to FIG. 3B, the receiver system 100, in determining whether it should select antenna j or antenna i in FIG. 3A for signal decoding, may first dwell on antenna i, if antenna i was selected as the starting antenna. Once the signal is detected, the gain Gᵢ may be determined for antenna i. The processor 106 may determine an estimated received power Pᵢ for antenna i. The processor 106 may then dwell on antenna j by notifying the antenna switch 104 to select antenna j for detection. The gain Gⱼ for antenna j may be set to correspond to the gain Gᵢ for antenna i or to a predetermined value. Such case may occur, for example, if dynamic gain adjustment only uses the gain of antenna i and does not use other signal quality metrics in setting the gain in antenna j. Because the signal in antenna i may be weaker than that in antenna j, if the gain Gⱼ for antenna j is set to correspond to the gain Gᵢ or larger, the signal in antenna j may be clipped and processor 106 may not be able to accurately determine the estimated received power Pⱼ for antenna j. The processor 106 may drop antenna j because it could not determine its estimated received power and may select antenna i for signal decoding. By setting the gain in all following antennas after the starting antenna to correspond to a reduced portion of the gain of the starting antenna, the receiver system 100 may avoid signal saturation and be able to select the correct antenna for signal decoding.

FIG. 3C illustrates exemplary antenna dwell times, dynamic gain control, and antenna selection, in accordance with an embodiment of the invention. Referring to FIG. 3C, the receiver system may dynamically control the gain Gⱼ to be applied to antenna j by applying a gain GᵢLⱼ, where Lⱼ is the power coupling factor between antenna j and antenna i. The coupling power factor Lⱼ may be used to reduce the gain and to guarantee that signal saturation may not result in the incorrect selection of the best antenna for signal decoding. Because the coupling power factors 118 may be known from the antenna switch 104 specification or may be measured prior to the operation of receiver system 100, they may be stored in memory 108 and may be used by the processor 106 to dynamically control the gain in all following antennas after the starting antenna. The processor 106 may apply a gain GₛLⱼ, where Gₛ corresponds to the gain of the starting antenna, whichever one may be selected as the starting antenna by processor 106, and Lⱼ corresponds to the power coupling factor between the current dwelling antenna j and the starting antenna. When the processor dwells on a following antenna k, and the estimated received power of antenna k corresponds to the strongest signal, the processor 106 may select antenna k as the best antenna and may apply a gain GₖLᵢ to antenna i, where Gₖ corresponds to the gain of antenna k and Lᵢ corresponds to the power coupling factor between the current dwelling antenna i and the best antenna or antenna k.

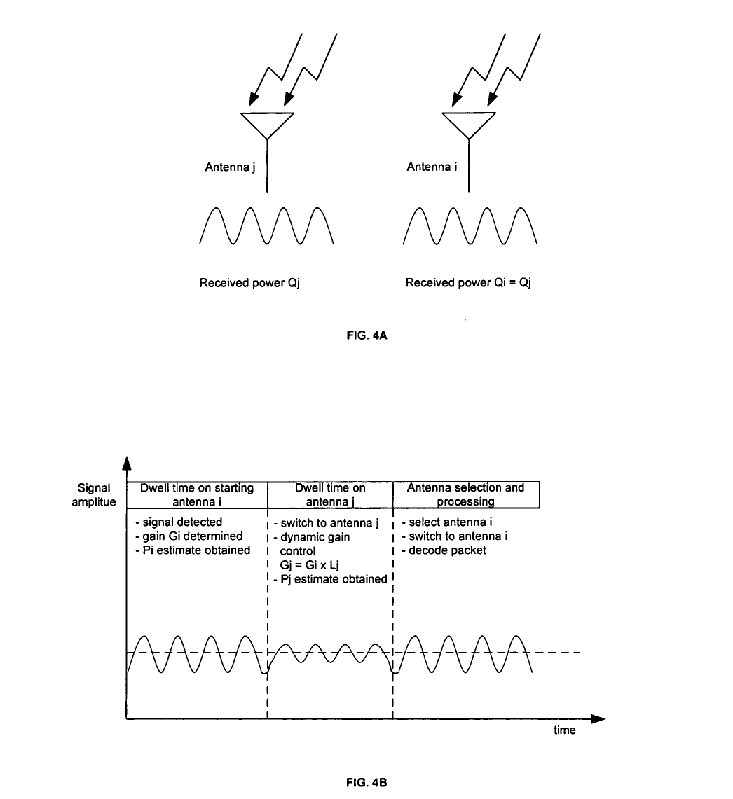

FIG. 4A illustrates exemplary received powers by different antennas in a receiver system, in accordance with an embodiment of the invention. Referring to FIG. 4A, in this exemplary illustration the receiver system 100 may be a two antenna system comprising antenna j and antenna i. The receiver system 100 may determine whether antenna j or antenna i may be selected as the best antenna for decoding the incoming frame or packet information. Antenna j and antenna i receive the same incoming power (Qᵢ=Qⱼ) and therefore receiver system 100 may select either antenna j or antenna i for signal decoding.

FIG. 4B illustrates exemplary antenna dwell times, dynamic gain control, and antenna selection, in accordance with an embodiment of the invention. Referring to FIG. 4B, the receiver system 100, in determining whether it should select antenna j or antenna i in FIG. 4A for signal decoding, may first dwell on antenna i, if antenna i was selected as the starting antenna. Once the signal is detected, an AGC is applied to antenna i to determine the gain Gᵢ for antenna i. The processor 106 may determine an estimated received power Pᵢ for antenna i after the AGC has settled. The processor 106 may then dwell on antenna j by notifying the antenna switch 104 to select antenna for detection. The gain Gⱼ for antenna j may be set by processor 106 to correspond to GᵢLⱼ, where Gᵢ corresponds to the gain of antenna i and Lⱼ corresponds to the power coupling factor between antenna j and antenna i. While the processor 106 may compensates for the lower applied gain in antenna j and may determine that the received power is the same in both antenna j and antenna i, the processor 106 may select antenna i over antenna j in this case because antenna j may be more susceptible than antenna i to transients signals, to capacitative or inductive coupling, and/or to other noise sources. Because the starting antenna may generally have longer dwelling times and an AGC may be used, the starting antenna may, in general, be less susceptible than other antennas to transients signals, to capacitative or inductive coupling, and/or to other noise sources.

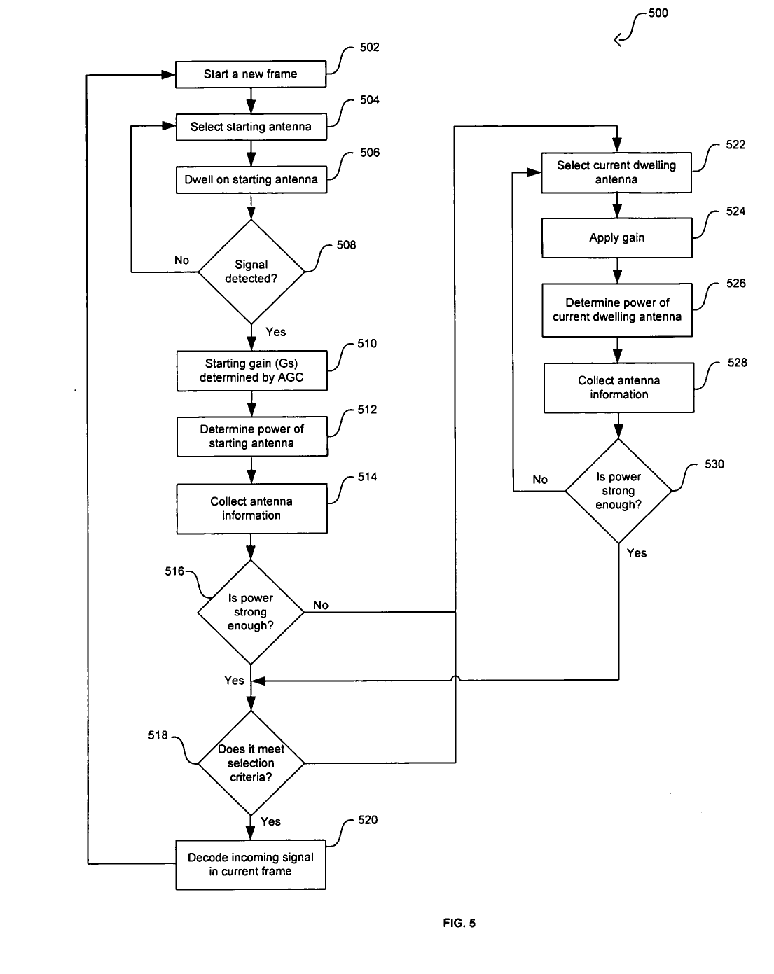

FIG. 5 is a flow chart illustrating exemplary steps that may be utilized in a receiver system for antenna selection with dynamic gain control, in accordance with an embodiment of the invention. Referring to FIG. 5, the receiver system 100 may start receiving a new frame in step 502. The processor 106 may select in step 504 the starting antenna based on a predetermined criteria, based on a random selection, and/or based on history of prior antenna selection. The the starting antenna may be selected based on a different selection criterion from frame-to-frame. In step 506, the processor 106 may dwell on the starting antenna for a predetermined amount of time or until an event may indicate completion of dwelling in that starting antenna. In step 508, the processor 106 may determine whether the desired signal has been detected in the starting antenna. If the signal has not been detected after a certain amount of time, or under other performance criteria, the processor 106 may select a different starting antenna and return to step 504. If the signal has been detected within predefined performance constraints, the processor 106 may proceed to step 510. In step 510, the gain Gₛ of the starting antenna may be determined by AGC or by the processor 106. In step 512, the processor 106 may determine the estimated received power of the starting antenna or it may determine the received power of the starting antenna. In step 514, the processor 106 may collect information on the gain Gₛ of the starting antenna, the estimated power of the starting antenna, and/or the received power of the starting antenna, and store it in memory 108.

In step 516, the processor 106 may determine whether the signal quality metric at the starting antenna is strong enough. The signal quality metric may refer to the received power, Q, or to the estimated received power, P. To determine whether the signal quality metric is strong enough, the processor may compare the signal quality metric from step 512 to a threshold level. For example, if the signal in the starting antenna is at least 40 dB above noise, then the signal may be strong enough for detection and decoding. If the signal quality metric is determined to be adequate, then the processor 106 may proceed to step 518. In step 518, the processor 106 may determine if the signal quality metric in the starting antenna meets a selection criteria so that the starting antenna may be selected as at least one of the antennas that may be used for signal detection and signal decoding. The selection criteria may depend, for example, on the gain setting for the antenna, on the location of the antenna, on the number of antennas that may be selected, on the number or antennas that may have been dwelled on thus far, on the history of prior antenna selection, on the history of prior collected antenna information, and/or on an optimal amount of time that the receiver system 100 to detect and decode an antenna signal. If the antenna meets the selection criteria, the processor 106 may proceed to step 520 and decode the incoming signal from the selected antenna in the current frame. After decoding, the processor 106 may proceed back to step 502 and start a new frame.

If in step 516 the signal quality metric in the starting antenna was not adequate to meet or exceed the threshold level, the processor 106 may proceed to step 522 where it may select a current dwelling antenna based on prior antenna selection history, based on a random selection, and/or based on a predetermined dwelling schedule. The processor 106 may apply a gain to the current dwelling antenna in step 524. The gain may depend on the collected gain, collected power information, and/or on the power coupling factors of all antennas dwelled on by the processor 106 thus far. In the case where the only antenna dwelled on is the starting antenna, the gain in step 524 may depend on the collected gain, collected power information in step 514 and/or on the power coupling factor between the current dwelling antenna and the starting antenna. For example, the gain setting may be GₛL_{d}, where L_{d} corresponds to the coupling factor between the current dwelling antenna and the starting antenna. In step 526, the processor 106 may determine the signal quality metric of the current dwelling antenna. The signal quality metric may correspond to the estimated received power, P, or the received power, Q, of the current dwelling antenna. In step 528, the processor 106 may collect the antenna performance information and store it in memory 108.

In step 530, the processor 106 may determine whether the signal quality metric of the current dwelling antenna is adequate. The signal quality metric may refer to the received power, Q, or to the estimated received power, P. To determine whether the signal quality metric is adequate, the processor may compare the signal quality metric from step 526 to a threshold level. The threshold level in step 530 may be the same as the threshold level in step 516 or may be different. If the signal quality metric is not adequate, the processor 106 may return to step 522 and select a different current dwelling antenna from the remaining antennas in the receiver system 100. If the signal quality metric is adequate, the processor 106 may proceed to step 518 and determine whether the antenna performance meets or exceeds a specified selection criteria. If the current dwelling antenna meets or exceeds the selection criteria in step 520, then the processor 106 may proceed to step 520 and then to a new frame in step 502.

In one aspect of the present invention, carrier detection and full automatic gain control (AGC) may be performed on a target antenna, whereas only dynamic gain control may be performed while dwelling on a second and subsequent antennas. Accordingly, the signal received on the target antenna may be verified as a valid frame before its power is estimated. However, for any remaining antennas, the time constraints may only permit power estimation and no carrier detection. During antenna selection diversity with dynamic gain control, different gain values may be applied to different antennas. As a result, a small dynamic gain may be applied so that the signal may be undetectable. For example, a dynamic gain value may be applied to a weak signal. The signal may then be corrupted by noise, or it may be on the same order as the noise. In this case, after applying the corresponding dynamic gain value, an incorrect power estimate may be obtained, which may lead to incorrect antenna selection.

Implementing a minimum power threshold may safeguard against using unreliable power estimates in the antenna selection process. Performance of the selection diversity scheme may be increased by minimizing the probability of choosing the incorrect receive antenna for processing. As a result, the performance of a receiver, transmitter and/or a transceiver device may be increased significantly.

In another aspect of the invention, antenna selection diversity with minimum threshold may be accomplished by discarding a power estimate for a given antenna if the power estimate falls below a minimum threshold. For example, an antenna i may be selected as a target antenna and automatic gain control and source detection may be applied to antenna i. Antenna i may be associated with a higher dwelling time and a better power estimate than any other antenna. In order for antenna i to be discarded and an antenna j selected as the target antenna, the estimated power Pⱼ for antenna j may need to be higher than the estimated power Pᵢ for antenna i, as well as the estimated power Pⱼ for antenna j may need to be greater than a minimum threshold T.

In yet another aspect of the present invention, antenna selection diversity may be accomplished with dynamic gain control and with biasing. In this case, in order for antenna i to be discarded and antenna j selected as the target antenna, the estimated power Pⱼ for antenna j may need to be higher than the estimated power Pᵢ for antenna i plus a bias value X units, for example. In addition, the estimated power Pⱼ for antenna j may need to be greater than a minimum threshold T. The minimum threshold value T may be the same value for each antenna or may be dynamically changed for each antenna. For example, if noise levels may be estimated for each antenna, the minimum threshold value T may be dynamically changed for each antenna in accordance with an estimated noise value for such antenna.

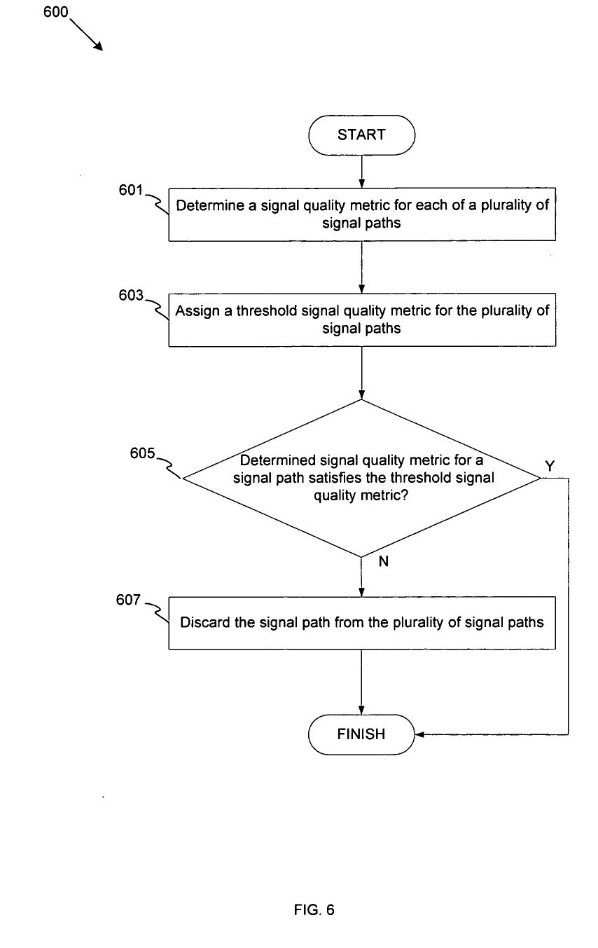

FIG. 6 is a flow diagram of an exemplary method 600 for selecting a signal path, in accordance with an embodiment of the invention. Referring to FIG. 6, at 601, a signal quality metric may be determined for each of a plurality of signal paths. At 603, a threshold signal quality metric may be assigned for the plurality of signal paths. At 605, it may be determined whether the signal quality metric for a signal path satisfies the threshold signal quality metric. If the signal quality metric for the signal path does not satisfy the threshold signal quality metric, at 607, the signal path may be discarded from the plurality of signal paths.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for selecting at least one signal path, the method comprising:
determining a signal quality metric for each of a plurality of signal paths;
assigning a threshold signal quality metric for the plurality of signal paths; and
discarding a signal path from the plurality of signal paths, if the determined signal quality metric for the signal path does not satisfy the threshold signal quality metric.

2. The method of claim 1, further comprising assigning a different threshold signal quality metric for each of the plurality of signal paths.

3. The method of claim 1, further comprising assigning a fixed threshold signal quality metric for each of the plurality of signal paths.

4. The method of claim 1, further comprising dynamically changing the threshold signal quality metric for each of the plurality of signal paths.

5. The method of claim 1, wherein the signal quality metric comprises at least one of a power level characteristic, a packet error rate characteristic, a bit error rate characteristic, a propagation channel characteristic, and an interference level characteristic.

6. The method of claim 1, wherein at least one of the signal paths comprises an antenna.

7. The method of claim 1, wherein each of the plurality of signal paths comprises at least one of a receive signal path and a transmit signal path.

8. A machine-readable storage having stored thereon, a computer program having at least one code section for selecting at least one signal path, the at least one code section being executable by a machine for causing the machine to perform steps comprising:
determining a signal quality metric for each of a plurality of signal paths;
assigning a threshold signal quality metric for the plurality of signal paths; and
discarding a signal path from the plurality of signal paths, if the determined signal quality metric for the signal path does not satisfy the threshold signal quality metric.

9. The machine-readable storage according to claim 8, further comprising code for assigning a different threshold signal quality metric for each of the plurality of signal paths.

10. The machine-readable storage according to claim 8, further comprising code for assigning a fixed threshold signal quality metric for each of the plurality of signal paths.

11. The machine-readable storage according to claim 8, further comprising code for dynamically changing the threshold signal quality metric for each of the plurality of signal paths.

12. The machine-readable storage according to claim 8, wherein the signal quality metric comprises at least one of a power level characteristic, a packet error rate characteristic, a bit error rate characteristic, a propagation channel characteristic, and an interference level characteristic.

13. The machine-readable storage according to claim 8, wherein at least one of the signal paths comprises an antenna.

14. The machine-readable storage according to claim 8, wherein each of the plurality of signal paths comprises at least one of a receive signal path and a transmit signal path.

15. A system for selecting at least one signal path, the system comprising:
at least one processor that determines a signal quality metric for each of a plurality of signal paths;
the at least one processor assigns a threshold signal quality metric for the plurality of signal paths; and
the at least one processor discards a signal path from the plurality of signal paths, if the determined signal quality metric for the signal path does not satisfy the threshold signal quality metric.

16. The system of claim 15, wherein the at least one processor assigns a different threshold signal quality metric for each of the plurality of signal paths.

17. The system of claim 15, wherein the at least one processor assigns a fixed threshold signal quality metric for each of the plurality of signal paths.

18. The system of claim 15, wherein the at least one processor dynamically changes the threshold signal quality metric for each of the plurality of signal paths.

19. The system of claim 15, wherein the signal quality metric comprises at least one of a power level characteristic, a packet error rate characteristic, a bit error rate characteristic, a propagation channel characteristic, and an interference level characteristic.

20. The system of claim 15, wherein at least one of the signal paths comprises an antenna.

21. The system of claim 15, wherein each of the plurality of signal paths comprises at least one of a receive signal path and a transmit signal path.
